(19) United States
(12) Patent Application Publication
(10) Pub. No.: US 2009/0314739 A1
(43) Pub. Date: Dec. 24, 2009

(54) WET PROCESSING SYSTEM AND WET PROCESSING METHOD

(75) Inventors: CHIH-KANG YANG, Tayuan (TW); WEN-CHIN LEE, Tayuan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN ADVANCED TECHNOLOGY INC., Tayuan (TW)

(21) Appl. No.: 12/345,896

(22) Filed: Dec. 30, 2008

(30) Foreign Application Priority Data
Jun. 19, 2008 (CN) 200810302230.8

(51) Int. Cl. B44C 1/22; C23F 1/08

(52) U.S. Cl. 216/13; 156/345.21

(57) ABSTRACT

An exemplary system for processing a workpiece comprises a conveyor, a first liquid spraying device, a second liquid spraying device, and a substrate positioning device. The conveyor is configured for conveying the workpiece along a conveying direction. The first and second liquid spraying devices for spraying liquid onto the workpiece transported on the conveyor face the conveyor and are arranged along the conveying direction. The substrate positioning device for reorienting the workpiece on the conveyor is installed between the first and second liquid spraying devices and faces the conveyor.

### BACKGROUND

1. Technical Field

The present disclosure relates to a wet processing system, and particularly, to a wet processing system with a substrate positioning device, and a related wet processing method.

2. Description of Related Art

At present, as the electronic appliances are becoming smaller in size and diversified in function, printed circuit boards (PCBs) widely used as a key component in such electronic appliances are required to have higher circuit density and reliability, for mounting more various electronic components such as resistor, capacitor, and integrated circuits thereon. To enhance circuit density, a photoresist layer having elongated patterns in various directions is employed, for manufacturing a conductive pattern distributed in various directions to increase a space utility rate of the printed circuit boards and decrease a volume of the printed circuit boards.

Usually, a chemical etching process is used for etching the higher density conductive pattern on a copper clad laminate (CCL) as described below. First, the photoresist layer is applied on the CCL by screen printing method. Second, the CCL is driven to pass through an etching unit by a conveyor, thereby an etchant is sprayed simultaneously and evenly onto a surface of the CCL by a number of spray nozzles. As a result, the copper layer uncovered by the photoresist layer is etched and the conductive pattern is formed on the copper layer.

The uncovered copper layer typically includes a first area extended in a direction inclined at a smaller angle (e.g. less than 10 degree), and a second area extended in a direction inclined at a bigger angle (e.g. more than 60 degree). However, in an etching process of the uncovered copper layer, the flow and refresh rate of the etchant in the first area of the uncovered copper layer, can be different from that in the second area thereof during spraying process. Thereby, the first area is possibly etched more deeply or shallowly than the second area of the uncovered conductive layer. This will cause degradation of uniformity of the conductive pattern, i.e. short circuit.

Therefore, a new wet processing system and a wet processing method is desired to overcome the above mentioned problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a wet processing system according to an exemplary embodiment.

FIG. 2 is a top view of a substrate.

FIG. 3 is a cross sectional view of FIG. 2 along line III-III.

FIG. 4 is a top view of the substrate of FIG. 2 to be firstly processed on the wet processing system of FIG. 1.

FIG. 5 is a top view of the substrate of FIG. 2 to be secondly processed on the wet processing system of FIG. 1.

FIG. 6 is a top view of the processed substrate of FIG. 2.

### DETAILED DESCRIPTION OF THE EMBODIMENTS

An exemplary embodiment will now be described in detail below with reference to the drawings.

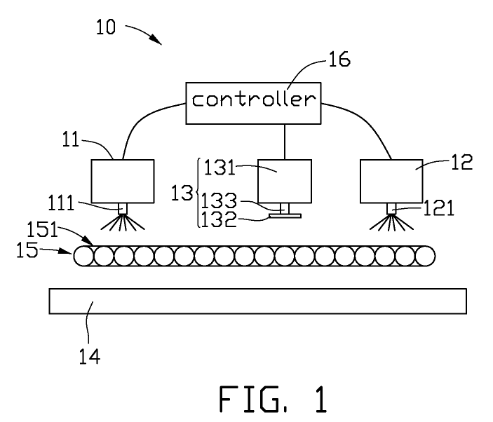

Referring to FIG. 1, a wet processing system 10 can be used in developing, etching, cleaning, and any other wet processes, in which a workpiece is processed with a corresponding liquid, such as developing agent, etchant, cleaning fluid. In the present embodiment, the system 10 is an etching system.

The system 10 includes a first liquid spraying device 11, a second liquid spraying device 12, a substrate positioning device 13, a liquid collection container 14, and a conveyor 15. The substrate positioning device 13 is installed between the first and second liquid spraying devices 11, 12. The conveyor 15 is configured for transporting a workpiece (e.g. a substrate) through the first liquid spraying device 11, the substrate positioning device 13 and the second liquid spraying device 12.

The first liquid spraying device 11 faces the conveyor 15, and is configured for spraying liquid (e.g. etchant) onto the substrate on the conveyor 15 thereby etching the substrate. The first liquid spraying device 11 can include single-sided and double-sided nozzles. The single-sided nozzles is capable of spraying liquid from a single side, and the double-sided nozzles is capable of spraying the liquid from two opposite sides to perform single-sided and double-sided wet processes of the substrate. When the first liquid spraying device 11 has the double-sided nozzles, the conveyor 15 correspondingly employs a plurality of spaced rollers to perform transportation. In the illustrated embodiment, the first liquid spraying device 11 has a first spray nozzle 111.

The second liquid device 12 is similar to the first liquid spraying device 11 in structure and function, and has a second spray nozzle 121 facing the conveyor 15. The second spray nozzle 121 is configured for spraying the liquid onto a single side of the conveyor 15. In the present embodiment, the first and second liquid devices 11, 12 are aligned along a line and located at the same side of the conveyor 15.

The substrate positioning device 13 faces the conveyor 15 and is configured for reorienting the workpiece on the conveyor 15. The substrate positioning device 13 can be arranged at each of two opposite sides of the conveyor 15. For example, the substrate positioning device 13 can be aligned with the first and second liquid devices 11, 12 at the same side of the conveyor 15. The substrate positioning device 13 can also be located at another side of the conveyor 15 opposite to the first and second liquid devices 11, 12.

In the present embodiment, the substrate positioning device 13 and the first, second liquid devices 11, 12 are aligned along a line. The substrate positioning device 13 includes a main body 131, a grasping member 132 and a linear driving member 133 connected between the main body 131, and the grasping member 132. The grasping member 132 can be a vacuum grasping member, such as a vacuum suction nozzle or a vacuum suction plate, and is adopted for grasping the substrate on the conveyor 15. An end of the linear driving member 133 is rotatably mounted on a main body 131, and another end is connected to grasping member 132. In operation, the linear driving member 133 rotates around a rotational axis that is substantially perpendicular to a main plane defined by conveyor 15, and also linearly moves towards and away from the conveyor 15. Thus, the grasping member 132 can be driven by the linear driving member 133 to linearly move and rotate in such a mentioned manner to achieve positioning the substrate on the conveyor 15.

The liquid collecting container 14 for collecting the liquid sprayed from the first and second nozzles 111, 121, is arranged on another side of the conveyor 15 opposite to the first and second liquid devices 11, 12. The liquid collecting container 14 can be a single container unit, and also include two sub-containers unit opposite to the first and second liquid devices 11, 12 correspondingly. In the described embodiment, the liquid collecting container 14 with a single container unit, is located at an opposite side of the conveyor 15 in relation to the first and second liquid spraying devices 11, 12. Correspondingly, an open end of the liquid collecting container 14 faces the conveyor 15.

The conveyor 15 can include a plurality of axially parallel spaced rollers, and a plurality of coaxially rotating juxtaposed conveyor belts to transport the substrate. For example, the coaxially rotating juxtaposed conveyor belts (not shown) can provide a passage between two adjacent conveyor belts, to allow the etchant sprayed from the spraying devices 11, 12 to flow from the conveyor belts into the liquid collecting container 14. The conveyor 15 includes a supporting surface 151 (i.e. the main plane of the conveyor 15). The supporting surface 151 faces the first spray nozzles 111, the second spray nozzles 121 and the grasping member 132, and is configured for placing the substrate on the supporting surface 151. Additionally, the conveyor 15 is cooperatively connected to a transporting mechanism of other wet processes performing different functions (e.g. cleaning), thereby obtaining a continuous production.

A controller 16 is further employed within the system 10. The controller 16 is electrically coupled to the first and second spraying devices 11, 12 and the substrate positioning device 13, for controlling at least one of spray-liquid of the first and second spraying devices 11, 12 and operation (e.g. movement and rotation) of the substrate positioning device 13.

Additionally, the system 10 includes a cleaning device (not shown) arranged between the first spraying device 11 and the substrate positioning device 13, to clean the substrate processed by the first spraying device 11 before the substrate positioning device 13 positions the substrate.

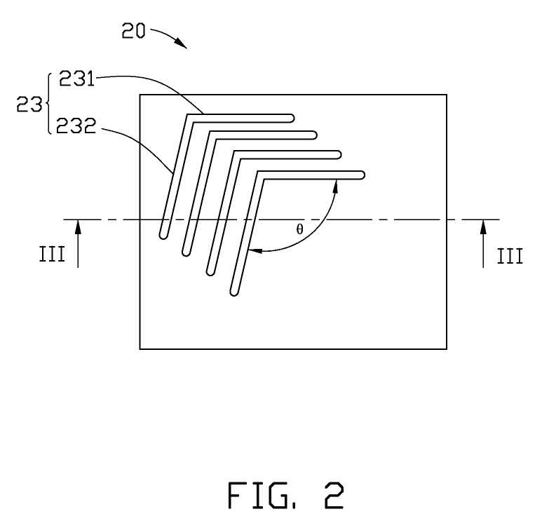

With reference to FIGS. 2 to 6, a wet processing method (e.g. developing, etching, and cleaning method) using the system 10 is described as following. To clearly explain series steps of the wet processing method in the present embodiment, an etching method as an exemplary embodiment is detailedly illustrated below.

Step 1: a workpiece 20 (i.e. a substrate 20) transported via the conveyor 15 is provided.

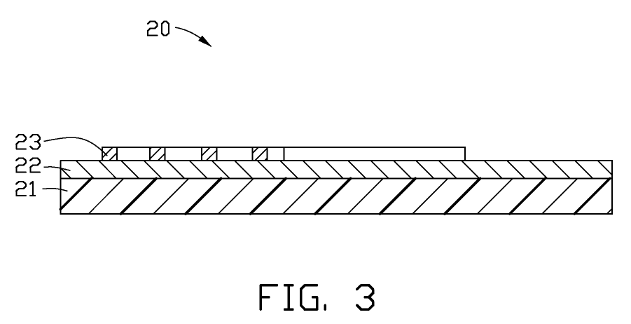

Referencing to FIG. 2 and FIG. 3, the substrate 20 is ready for exposure and developing and further made into a printed circuit board or a semiconductor chip with single-sided or double-sided electrical traces. In the illustrated embodiment, the subtract 20 includes a base film 21, a metal layer 22 and a patterned photoresist layer 23. The metal layer 22 is interposed between the base film 21 and the patterned photoresist layer 23, for forming single-sided electrical traces.

The base film 21 can either be a single layer structure including an insulating film or a multilayer structure containing a number of insulating films and a number of electrical circuit layer arranged alternately. When the base film 21 is the single layer structure, the base film 21 can be made of a material selected from a group consisting of polyimide, polyester, polytetrafluoroethylene, polymethyl methacrylate and polycarbonate. When the base film 21 is the multilayer structure, an outmost layer of the multilayer structure should be an insulating film so as to the metal layer 22 can be interposed between the outmost insulating film of the base film 21 and the patterned photoresist layer 23. In the present embodiment, the base film 21 is a single layer polyimide film.

The metal layer 22 is selected from a pure metal layer, such as a copper layer, or a silver layer, and a alloy layer with better electro-conductivity, such as a copper-nickel alloy layer, or a copper-platinum alloy layer. The metal layer 22 can be formed on one side of the base film 21 by a sputtering process, a laminating process or an electroplating process. The metal layer 22 of the present embodiment is a copper layer.

The patterned photoresist layer 23 is formed on the copper layer 22 (i.e. metal layer) by previous exposing and developing processes. Portions of the copper layer 22 are exposed from the patterned photoresist layer 23, and will be removed from the base film 11 in the following etching processes. Thus, residual portions of the copper layer 22 covered by the patterned photoresist layer 22 will form a patterned copper layer, i.e., a desired electrical traces.

The patterned photoresist layer 23 comprises a first elongated region 231 and a elongated region 231 connected to the first elongated region 231. As shown in FIG. 2, the first elongated region 231 has a number of parallel lines relative to a first direction 101. The second elongated region 232 has a number of parallel lines relative to a second direction. The first direction is slanted at an angle θ clockwise from the second direction 102. That is, the first elongated region 231 and the second elongated region 232 form the angle θ along a clockwise direction between them. Alternatively, the first elongated region 231 can also include an amount of lines oriented along a direction inclined at an angle less than 5 degrees relative to the first direction 101, instead of the parallel lines. Similarly, the second elongated region 232 can also include an amount of lines oriented along a direction inclined at an angle less than 5 degree relative to a second direction 102, instead of the parallel lines.

Step 2: the first spraying device 11 performs a first etching process of the substrate 20.

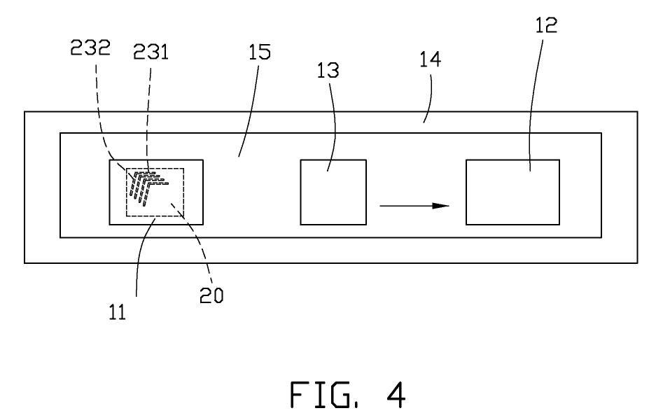

Referring to FIG. 1 and FIG. 4, in the first etching process, firstly, the convey 15 transports the substrate 20 in direction parallel to the extending direction of the first elongated region 231 to a predetermined position under the control of the controller 16. Secondly, when the substrate 20 directly faces the first spraying device 11, the controller 16 drives the first spray nozzle 111 of the first spraying device 11 to spray the copper etchant towards the substrate 20 on the convey 15. The sprayed copper etchant etches the corresponding portions of the copper layer 22 so as to remove portions of the copper layer 22 exposed from the patterned photoresist layer 23. In the present embodiment, the copper etchant is an acidic copper chloride solution including copper chloride(CuCl₂), hydrochloric acid (HCl) and peroxide (H₂O₂). It is understood that other suitable copper etchant can also be used, for example, an acidic iron chloride solution.

It is known that, compared with along other directions, a flow rate of the sprayed copper etchant on the substrate 20 is accelerated along a direction parallel to the conveying direction of the substrate 20 (i.e. the first direction 101). Therefore, the sprayed copper etchant flows and refreshes at a higher rate on a portion of the copper layer 22 extending in a direction parallel to the first direction 101, than on another portion of the copper layer 22 extending in other directions (e.g. parallel to the second direction 102). As a result, the portion of the copper layer 22 extending in a direction parallel to the second direction 101 is substantially removed, but other portion of the copper layer 22 extending in a direction parallel to the second direction 102 fails to be completely removed and still remains copper on the base film 11.

Step 3: the substrate positioning device 13 grasps and rotates the substrate 20 to enable the second elongated region 232 of the substrate 20 to be parallel to a conveying direction of the conveyor 15.

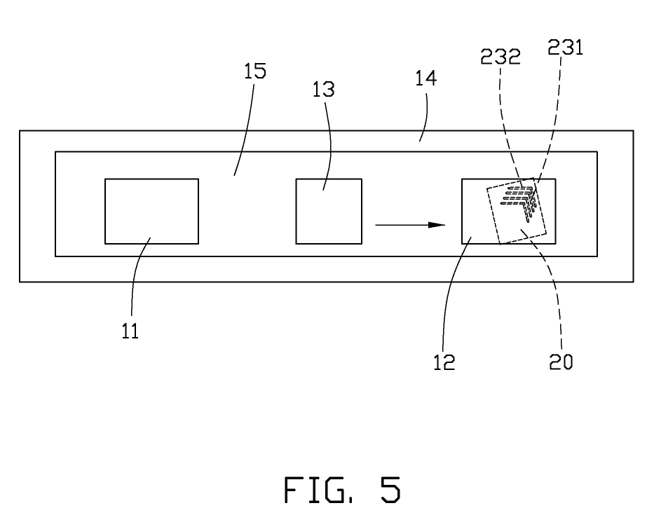

Referring to FIG. 1 and FIG. 5, under controlling of the controller 16, firstly, the linear driving member 133 of the substrate positioning device 13 moves downwardly towards the substrate 20 on the conveyor 15. Secondly, the grasping member 132 grasps the substrate 20 away from the supporting surface 151 of the conveyor 15 as the linear driving member 133 linearly moves away from the conveyor 15, and then rotates the substrate 20 clockwise around the rotation axial direction to the angle θ. Thirdly, the linear driving member 133 moves towards the conveyor 15 and places the rotated substrate 20 on the supporting surface 151. The second elongated region 232 of the substrate 20 is parallel to the conveying direction of the conveyor 15. Alternatively, the linear driving member 133 can also rotate the grasped substrate 20 anti-clockwise around the rotation axial direction to an angle (180-θ).

Step 4: the second spraying device 12 performs a second etching process of the substrate 20.

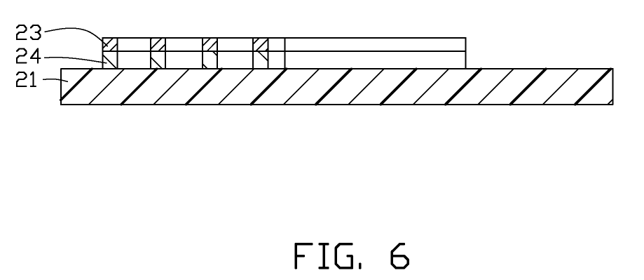

Referring to FIG. 1, FIG. 5 and FIG. 6, the second etching process is same to the first etching process. The rotated substrate 20 is conveyed in direction parallel to the extending direction of the second elongated region 232 by the convey 15 controlled under the controller 16, and etched the remained copper in the step 2 by a copper etchant from the second spray nozzle 121 of the second spraying device 12. As a result, the copper remnants from step 2 is fully removed from the base film 21, and the residual portion of the copper layer 22 forms the desired electrical traces. Finally, the second etched substrate is cleaned for use in continuous steps.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A system for processing a workpiece comprising:
a conveyor for conveying the workpiece along a conveying direction;
a first and a second liquid spraying devices facing the conveyor and arranged along the conveying direction, for spraying liquid onto the workpiece transported on the conveyor; and
a substrate positioning device installed between the first and second liquid spraying devices and facing the conveyor, the substrate positioning device configured for reorienting the workpiece on the conveyor.

2. The system as claimed in claim 1, wherein the substrate positioning device comprises a grasping member for grasping the workpiece on the conveyor and a linear driving member for rotating the grasping member around a rotation axis that is substantially perpendicular to a main plane defined by the conveyor.

3. The system as claimed in claim 2, wherein the linear driving member is configured for linearly moving the grasping member toward or away from the conveyor.

4. The system as claimed in claim 1, wherein the first, second liquid spraying devices and the substrate positioning device are aligned along the conveying direction.

5. The system as claimed in claim 1, further comprising a liquid collecting container for collecting liquid sprayed from the first and second liquid spraying devices arranged opposite to the first and second liquid spraying devices, and the substrate positioning device.

6. The system as claimed in claim 1, wherein the first and second liquid spraying devices contains and sprays an etchant.

7. The system as claimed in claim 1, wherein the first liquid spraying device includes a single-sided spray nozzle or double-sided spray nozzles.

8. The system as claimed in claim 1, wherein the second liquid spraying device is similar to the first liquid spraying device in structure.

9. The system as claimed in claim 1, further comprising a controller for controlling at least one of spray-liquid of the first and second liquid spraying devices, and operation of the substrate positioning device.

10. A method for processing a workpiece, comprising:
conveying the workpiece using a conveyor to a first liquid spraying device;
spraying liquid towards the workpiece using the first liquid spraying device;
reorienting the workpiece relative to the conveyor;
conveying the workpiece using the conveyor to a second liquid spraying device after being reoriented;
spraying liquid towards the workpiece using the second liquid spraying device.

11. The method as claimed in claim 10, wherein the reorienting step comprises grasping the workpiece, then rotating the grasped workpiece relative to the conveyer.

12. The method as claimed in claim 10, wherein the workpiece comprises a base film, a metal layer formed on the base film, and a patterned photoresis layer disposed on the metal layer, the patterned photoresis layer comprises a first elongated region and a second elongated region obliquely relative to the first elongated region, a portion of the metal layer being exposed from the patterned photoresis layer, wherein the first elongated region is oriented along a conveying direction of the conveyor prior to the reorienting step.

13. The method as claimed in claim 12, wherein the second elongated region is oriented along the conveying direction of the conveyor after the reorienting step.

14. The method as claimed in claim 12, wherein the metal layer is etched by etchant sprayed from the first and second liquid spraying device.
